(19) United States
(12) Patent Application Publication
(10) Pub. No.: US 2003/0235278 A1
(43) Pub. Date: Dec. 25, 2003

(54) System and method for the distribution of multimedia messaging service messages

(76) Inventor: Toni Paila, Degerby (FI)

Correspondence Address: MORGAN & FINNEGAN, L.L.P., 345 Park Avenue, New York, NY, 10154-0053, US

(21) Appl. No.: 10/165,141

(22) Filed: Jun. 6, 2002

(51) Int. Cl. H04M 11/00

(52) U.S. Cl. 379/88.13; 379/88.12

(57) ABSTRACT

Systems and methods for the distribution of MMS (Multimedia Messaging Service) messages, and systems and methods for receiving such messages.

### FIELD OF THE INVENTION

This invention relates to systems and methods for data distribution.

### BACKGROUND OF THE INVENTION

In recent years, there has been an increase in the use of wired and wireless networks to distribute data and/or provide services to devices such as wireless terminals, personal computers, and PDAs. One emerging network service is MMS (Multimedia Messaging Service). MMS, for example, allows users to send and receive messages including various types of content such as video, audio, and text.

There has been a good deal of interest in MMS, and the 3rd Generation Partnership Project (3GPP) has drafted specifications concerning this technology. Accordingly, there may be increased interest in technologies that may facilitate the use of network services such as MMS.

### SUMMARY OF THE INVENTION

According to embodiments of the present invention, there are provided systems and methods for the distribution of MMS (Multimedia Messaging Service) messages.

Also provided are systems and methods for receiving such messages.

### BRIEF DESCRIPTION OF THE DRAWINGS

FIG. 1 shows an exemplary network arrangement according to embodiments of the present invention.

FIG. 2 is a flow chart showing steps involved in a first exemplary delivery method according to embodiments of the present invention.

FIG. 3 is a flow chart showing steps involved in a second exemplary delivery method according to embodiments of the present invention.

FIG. 4 is a flow chart showing steps involved in reception of a notification according to embodiments of the present invention.

FIG. 5 is a flow chart showing steps involved in reception of a MMS message according to embodiments of the present invention.

FIG. 6 shows an exemplary general purpose computer employable in various embodiments of the present invention.

FIG. 7 shows a functional block diagram of an exemplary terminal employable in various embodiments of the present invention.

### DETAILED DESCRIPTION OF THE INVENTION

General Operation

According to embodiments of the present inventions, there are provided systems and methods for delivering MMS (multimedia messaging service) messages to recipient terminals in a manner that does not require a recipient terminal to employ a return communications channel. Such system and methods may be useful in environments where terminals lack return communications channels to certain devices and/or other entities, and in situations where return channels are available but there are cost, speed, and/or other advantages to avoiding their use.

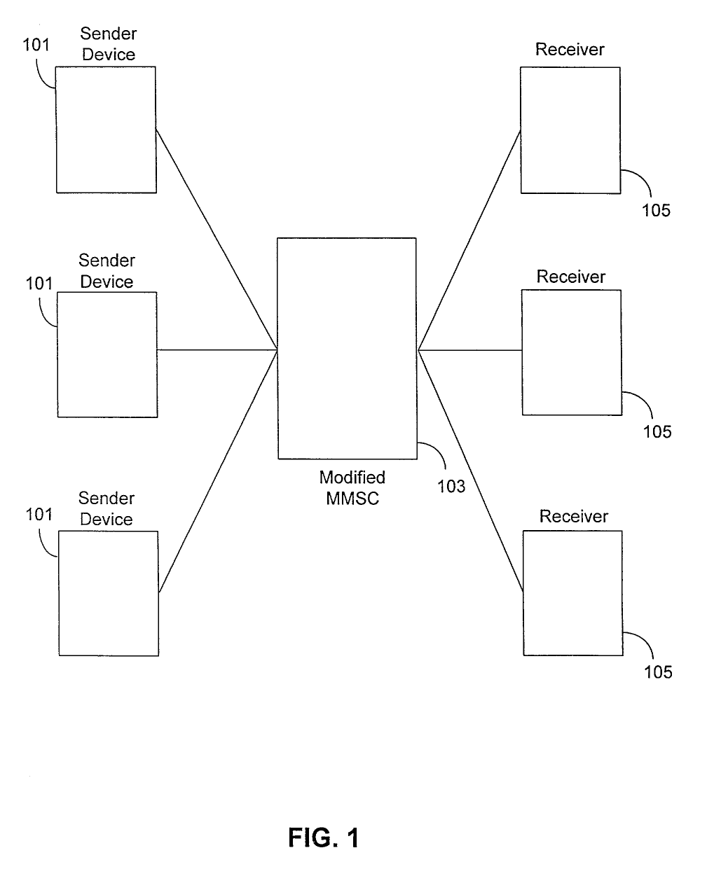

Shown in FIG. 1 is an exemplary network arrangement. According to embodiments of the invention, a sender device 101 may transmit an MMS message to a receiver terminal 105 via a modified MMSC (MMS Center) 103. More specifically, a message dispatched by a sender 101 for ultimate reception by a receiver 105 could first be received by modified MMSC 103.

According to certain embodiments, a decision could be made between having a modified MMSC handle a received message in a way that required a response from the message's recipient, and having the MMSC handle the message in a way that did not require a response from the message's recipient. As will be discussed in greater detail below, the decision could take into account a number factors, and could be made upon the receipt of a message by a modified MMSC, beforehand, or a short time after. The decision could be made, for example, by the modified MMSC itself, by a central computer, and/or by a system administrator. It is noted that, according to certain embodiments of the invention, no such decision might be made, and instead a modified MMSC might always act to handle a received message in a manner that does not require a response from the recipient.

Although a modified MMSC is shown in the exemplary network arrangement of FIG. 1, it is noted that certain embodiments of the present invention might not employ this element. For example, a conventional MMSC and a helper module might be employed in place of a modified MMSC. In such embodiments, those actions described herein with reference to a modified MMSC that are performable by a standard MMSC could be performed by the standard MMSC, while those actions described herein with reference to a modified MMSC that are not performable by a standard MMSC could be performed by the helper module.

Embodiments of the present invention may be employed in number of different types of networks. For instance, embodiments may be employed in wired networks, wireless networks, and/or networks having both wired and wireless portions. Furthermore, embodiments may be employed in unidirectional networks, bidirectional networks, and/or networks having both unidirectional and bidirectional portions. Accordingly, embodiments of the present invention are applicable to, for example, the Internet and wireless networks employing DVB-T (terrestrial digital video broadcast), DVB-S (satellite digital video broadcast), DVB-C (cable digital video broadcast), DAB (digital audio broadcast), 802.11b, GPRS (general packet radio service), UMTS (universal mobile telecommunications service), DRM (digital radio mondiale), and/or Bluetooth.

Various aspects of the invention will now be described in greater detail.

Determination of Distribution Technique

As noted above, perhaps upon a modified MMSC's receipt of a message, the MMSC or another entity might act to decide between handling the message in a way that requires a response from the recipient and a way that does not response from the recipient.

As a first step in making such a determination, the entity might first act to determine if a return channel is available between the recipient terminal and the modified MMSC. No return channel may be available, for example, if at least one of the modified MMSC and the recipient lacks the hardware required for such return communication operations. Such a situation might also occur if the necessary network infrastructure is not available. Necessary network infrastructure may be lacking, for example, if the modified MMSC and the recipient terminal are situated such that the only available network connectivity between the two is DVB-T from MMSC to terminal. In the case where it is determined that no return channel is available, it may be determined that the message be handled in a way that does not require a response from the recipient.

In the case where it is determined that a return channel is available, it may next be determined if there is an advantage to avoiding use of the return channel. The determination process may be implemented, for instance, such that avoiding use of the return channel is viewed as advantageous in the case where the cost of using the channel is above a certain predetermined value. In certain embodiments indications of advantageousness, perhaps quantifiable, other than cost may be considered. It is further noted that, in certain embodiments, a system administrator or the like might make the advantageousness decision, perhaps without performing formal calculations.

In the case where avoiding use of the return channel is determined to be advantageous, it may be decided to handle the message in a way that does not require a response from the recipient. In the case where avoiding use of the return channel is not determined to be advantageous, it may be decided to handle the message in a way that does requires a response from the recipient.

Alternately, as noted above, no such decision might be made, and instead a modified MMSC might always act to handle a received message in a manner that does not require a response from the recipient.

Message Distribution

As alluded to above, according to embodiments of the present invention a modified MMSC may, after receiving and storing an incoming message, act to distribute the message in either a manner that does not require a response from the recipient, or in a manner that does.

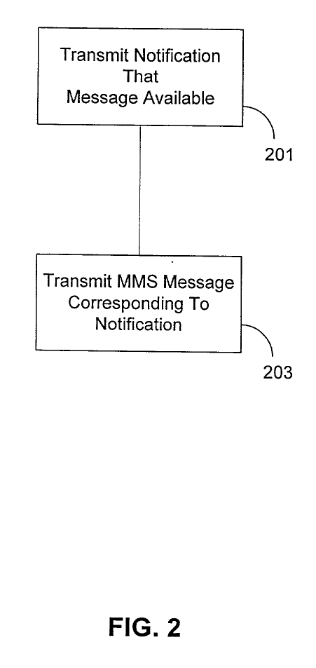

As is illustrated in FIG. 2, in the case where a modified MMSC acts to distribute a received message in a manner that does not require a response from the recipient, the MMSC might first dispatch, to the message's recipient, a notification that a message was available (step 201). The notification could include an indication that the MMS message would follow automatically, the indication perhaps additionally specifying the time at which the message would follow. The notification might also include an indication of the content of the message. For example, the indication might specify the size of the message, the type of message (e.g., video), and/or a synopsis of the message. The indication might further include a URL (universal resource locator) or other specification of the location from which the message itself could be requested.

A period of time after transmission of the notification, the modified MMSC might transmit to the recipient terminal the MMS message itself (step 203). As will be described in greater detail below, the recipient terminal could respond to the modified MMS's actions in such a manner that no return channel would need to be employed in order to comply with a user request to receive the message associated with a notification. Although in this illustrative example transmission of notification is shown as being prior to transmission of the corresponding MMS message, it is noted that other implementations are possible. For instance, transmission of notification might instead occur after or along with transmission of the corresponding MMS message.

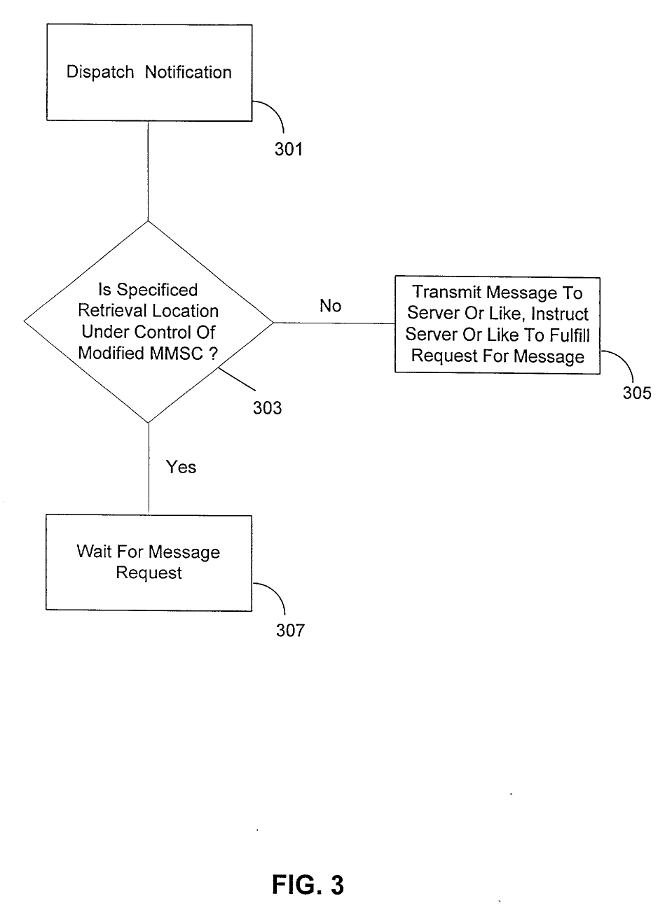

As is illustrated in FIG. 3, in the case where a modified MMSC acts to distribute a received message in a manner that requires a response from the recipient, the MMSC might first dispatch a notification (step 301). The notification could be similar to the notification described with reference to FIG. 2, including an indication of the location from which the message itself could be requested, but perhaps differing by including an indication that the MMS message would not follow automatically.

In the case where the specified retrieval location and/or the to-be-delivered multimedia message was not under the control of the modified MMSC, the MMSC might next transmit the message to the server or the like associated with the location, and instruct the server or the like to fulfill requests for the message (steps 303, 305). Alternately, in the case where the location from which the message itself could be requested was under the control of the modified MMSC, the MMSC might next wait for the message's intended recipient to dispatch a request for the message corresponding to the notification (steps 303, 307). The modified MMSC might do this, for example, by monitoring for appropriate HTTP (hypertext transfer protocol) or WSP (wireless session protocol) GET requests. Upon receipt of such a request, the modified MMSC could dispatch the message to the intended recipient.

It is noted that a notification and corresponding MMS message, as described in various embodiments and illustrative examples herein, could be delivered as two distinct messages (e.g., two separate messages corresponding two separate transmissions). Alternately, a notification and corresponding MMS message might be delivered as a single message containing two logical messages.

Terminal Operations

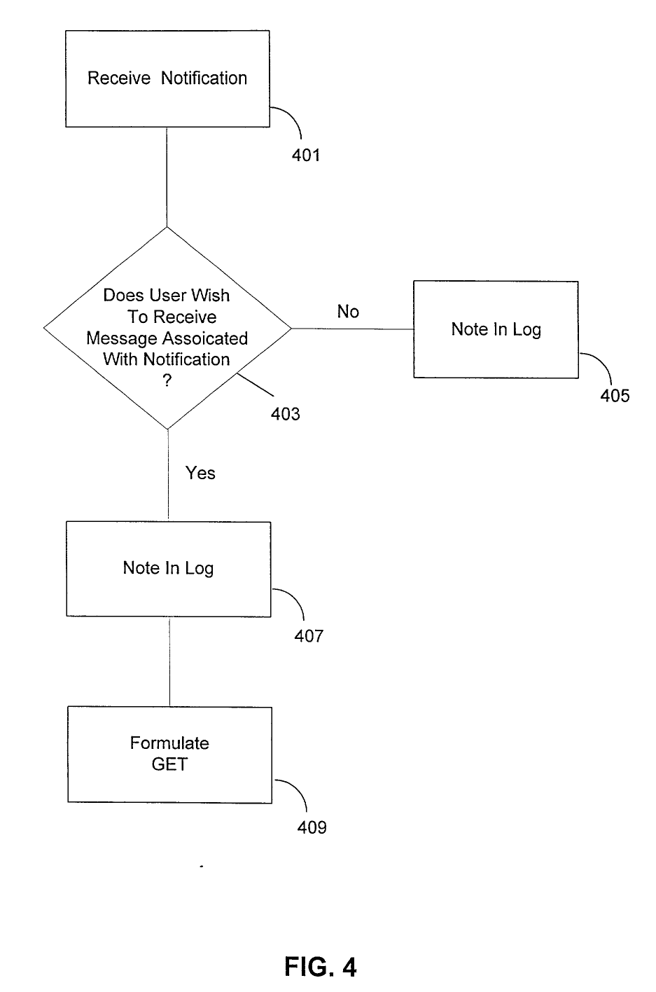

According to certain embodiments of the invention a terminal may respond to an incoming notification as illustrated in FIG. 4.

Upon receipt of a notification (step 401), a terminal could take steps to see if its user wished to receive the MMS message associated with the notification (step 403). The terminal could do this, for example, by presenting to its user a GUI (graphical user interface) dialog box posing the question and including buttons for “yes” and “no”.

In the case where the user answered “no”, the terminal could make a notation of this choice in a log (step 405). The terminal could additionally act to see if the message was in the terminal's cache. If it was, the terminal could act to delete the item from the cache. In the case where the user answered “yes”, the terminal might make a notation of this choice in a log (step 407) and formulate an HTTP or WSP GET directed to the location specified in the notification for fetching the message (step 409).

According to embodiments of the invention, such a GET request might be first directed to the terminal's web cache. If the item was found to be in the cache, the terminal could tell its user that the message was available, and might additionally ask the user if she wished to view it at that time. Alternately, the terminal might automatically display the message instead without querying the user. It is noted that, in the case where the desired message is in the cache, the GET request might not be transmitted by the terminal over a network to which it was connected. It is further noted that the GET request might not be dispatched outside of the terminal in the case where the notification had specified that the message would follow automatically, and/or in the case where the terminal lacked a return communications channel.

A terminal may lack a return communications channel, for example, if the terminal lacked the necessary hardware, if the necessary network infrastructure was unavailable, and/or if its user or another entity had determined that the return channel should not be used. Such a determination might be made, for example, based on monetary cost. Conditions under which a message corresponding to a notification might, at the time a user decided whether or not she wishes to receive the message, already be in a terminal's cache will be described in greater detail below.

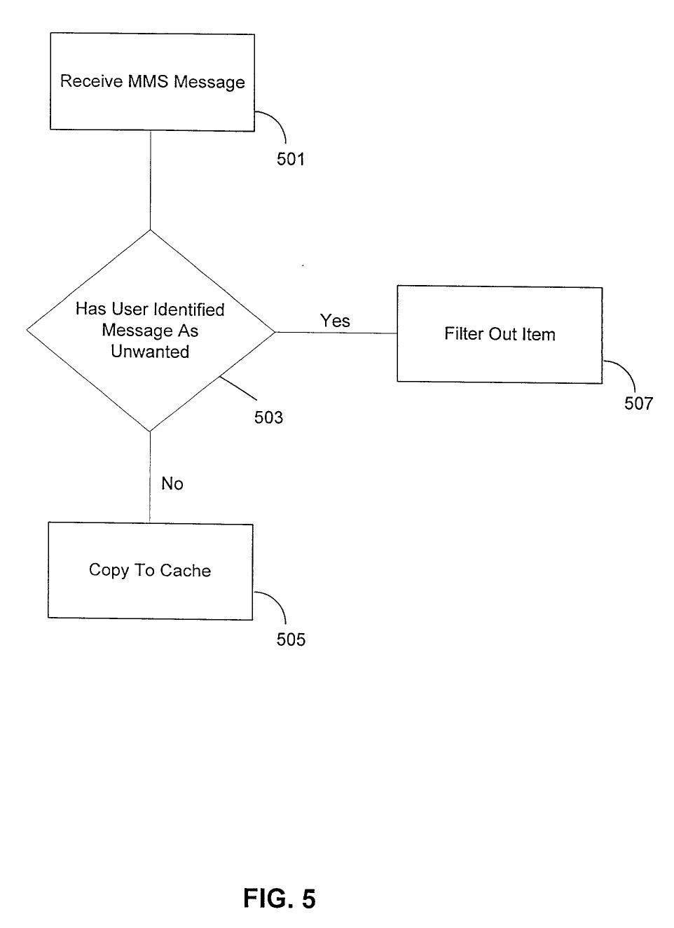

As illustrated in FIG. 5, upon receipt of a MMS message (step 501), a terminal could take steps to determine if its user had identified the message as one that she did not wish to receive (step 503). This terminal could achieve this, for example, by consulting the above-noted log. In the case where the item was found to not be identified by the user as unwanted, the item could be copied to the terminal's cache from the store or stores into which it was initially received and/or placed (step 505). If the item was found, in addition to not being specified as unwanted, to be identified by the user as desired, the user might also be notified of item's arrival. Under such circumstances, the terminal might perform the further operation of presenting the message to the user. In certain embodiments, the terminal might query the user before presenting the message.

In the case where the item was found to be identified by the user as unwanted, the terminal could take steps to filter out the item (step 507). In the case where the MMS message had been fully received at the terminal at the time that the terminal recognized it as one unwanted by the user, the terminal might delete the message from the store or stores into which it was initially received and/or placed. On the other hand, if only a portion of the notification had been received (e.g., only certain packets thereof), the terminal might act to delete any portions stored and to not save further incoming portions.

As noted above, the message corresponding to a notification may arrive at a terminal prior to, at the same time as, or after, the arrival of the notification. Accordingly, a terminal may perform the operations discussed with reference to FIG. 4 at the same time as the operations discussed with reference to FIG. 5.

As indicated above, an MMS message may be placed in a terminal's cache in the case where its user has neither identified the message as unwanted or as desired. Such a situation may occur, for example, if a MMS message arrived at a point in time where the terminal's user had not answered the terminal's query as to whether the message was unwanted or desired. As further indicated above, if the user subsequently indicated that the message was unwanted, the terminal might act to delete the message from the cache. It is noted that in certain embodiments a terminal might further delete such an MMS message from its cache if a predetermined amount of time passed wherein the user had neither identified the message as unwanted or as desired.

It is noted that, in certain embodiments, no delivery and/or receipt of notifications may be necessary. For instance, a terminal could receive an MMS message and store that message in its cache. In response to the reception, the terminal could generate a “local notification” corresponding to the message. The notification could be associated with a pointer or the like pointing to the cache. The terminal could make this notification available to, for instance, the user of the terminal and/or certain software running on the terminal. The MMS message could then be retrieved from and/or deleted from the cache as appropriate.

Hardware and Software

Certain devices employed in accordance with the present invention may be implemented using computers. For example, the above-noted sender devices, modified MMSC, and terminals may be implemented using network-capable computers. Furthermore, certain procedures and the like described herein may be executed by or with the help of computers. The phrases “computer”, “general purpose computer”, and the like, as used herein, refer but are not limited to a processor card smart card, a media device, a personal computer, an engineering workstation, a PC, a Macintosh, a PDA, a wired or wireless terminal, a server, a network access point, or the like, perhaps running an operating system such as OS X, Linux, Darwin, Windows CE, Windows XP, Palm OS, Symbian OS, or the like, perhaps with support for Java or .Net.

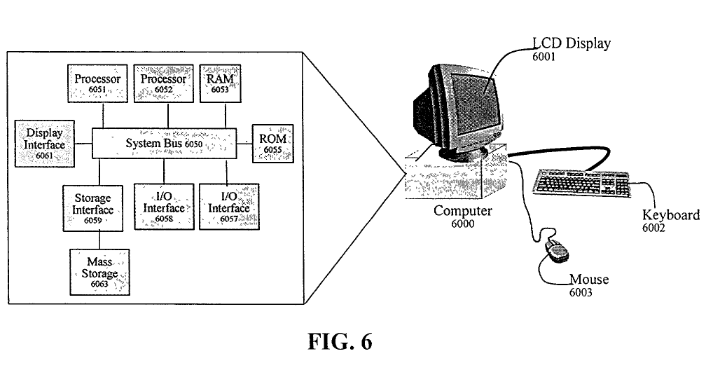

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 6000 as shown in FIG. 6 includes system bus 6050 which operatively connects two processors 6051 and 6052, random access memory (RAM) 6053, read-only memory (ROM) 6055, input output (I/O) interfaces 6057 and 6058, storage interface 6059, and display interface 6061. Storage interface 6059 in turn connects to mass storage 6063. Each of I/O interfaces 6057 and 6058 may be an Ethernet, IEEE 1394, IEEE 802.11b, Bluetooth, DVB-T, DVB-S, DAB, GPRS, UMTS, or other interface known in the art. Mass storage 6063 may be a hard drive, optical drive, or the like. Processors 6057 and 6058 may each be a commonly known processor such as an IBM or Motorola PowerPC, an AMD Athlon, an AMD Hammer, an Intel StrongARM, or an Intel Pentium. Computer 6000 as shown in this example also includes an LCD display unit 6001, a keyboard 6002 and a mouse 6003. In alternate embodiments, keyboard 6002 and/or mouse 6003 might be replaced with a touch screen, pen, or keypad interface. Computer 6000 may additionally include or be attached to card readers, DVD drives, or floppy disk drives whereby media containing program code may be inserted for the purpose of loading the code onto the computer.

In accordance with the present invention, a computer may run one or more software modules designed to perform one or more of the above-described operations, the modules being programmed using a language such as Java, Objective C, C, C#, or C++ according to methods known in the art.

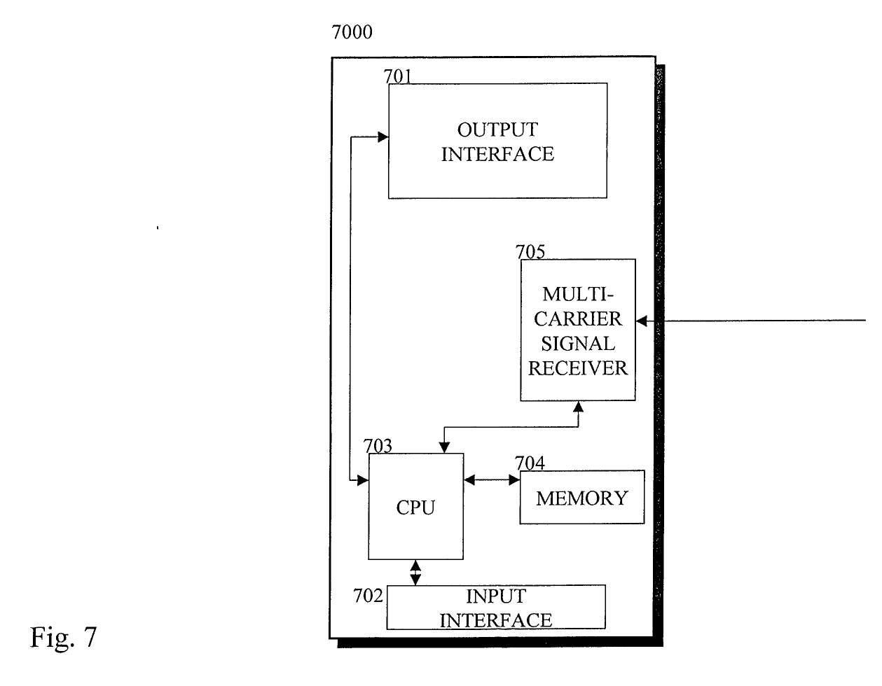

Shown in FIG. 7 is a functional block diagram of an exemplary terminal employable in various embodiments of the present invention. The terminal of FIG. 7 has been discussed in the foregoing. In the following, corresponding reference signs have been applied to corresponding parts. Terminal 7000 of FIG. 7 may be used in any/all of the embodiments described herein. The terminal 7000 comprises a processing unit CPU 703, a multi-carrier signal terminal part 705 and a user interface (701, 702). The multi-carrier signal terminal part 705 and the user interface (701, 702) are coupled with the processing unit CPU 703. The user interface (701, 702) comprises a display and a keyboard to enable a user to use the terminal 7000. In addition, the user interface (701, 702) comprises a microphone and a speaker for receiving and producing audio signals. The user interface (701, 702) may also comprise voice recognition (not shown).

The processing unit CPU 703 comprises a microprocessor (not shown), memory 704 and possibly software . The software can be stored in the memory 704. The microprocessor controls, on the basis of the software, the operation of the terminal 7000, such as the receiving of the data stream, the tolerance of the impulse burst noise in the data reception, displaying output in the user interface and the reading of inputs received from the user interface. The operations are described above. The hardware contains circuitry for detecting the signal, circuitry for demodulation, circuitry for detecting the impulse, circuitry for blanking those samples of the symbol where significant amount of impulse noise is present, circuitry for calculating estimates, and circuitry for performing the corrections of the corrupted data.

Still referring to FIG. 7, alternatively, middleware or software implementation can be applied. The terminal 7000 can be a hand-held device which the user can comfortably carry. Advantageously, the terminal 7000 can be a cellular mobile phone which comprises the multi-carrier signal terminal part 705 for receiving the broadcast transmission stream. Therefore, the terminal 7000 may possibly interact with the service providers.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. A method for distributing a multimedia messaging service message, comprising:
dispatching to a device a notification of the availability of a multimedia messaging service message directed to the device, said notification including an indication of a remote location from which the message may be requested; and
dispatching said message,
wherein said message is not dispatched in response to a received request for said message.

2. The method of claim 1, wherein said message is dispatched prior to the dispatching of said notification.

3. The method of claim 1, wherein said message is dispatched along with said notification.

4. The method of claim 1, wherein said message is dispatched after the dispatching of said notification.

5. The method of claim 1, further comprising:
determining if a return communications channel is available to said device.

6. The method of claim 5, further comprising:
ascertaining if there is an advantage to avoiding use of the return channel.

7. The method of claim 6, wherein said ascertaining comprises determining the cost of using said return channel.

8. The method of claim 1, wherein said notification further includes an indication that the message will follow automatically.

9. The method of claim 8, wherein said notification further includes a specification of the time at which the message would follow.

10. The method of claim 1, wherein said notification further includes an indication of the content of the message.

11. A method for receiving a multimedia messaging service message, comprising:
receiving at a device a notification of the availability of a multimedia messaging service message directed to the device, said notification including an indication of a remote location from which the message may be requested;
further receiving at said device, along with said notification, said message;
placing said message in a cache of said device;
formulating at said device a request to receive said message; and
employing said cache to satisfy said request.

12. The method of claim 11, wherein said notification further includes an indication that the message will follow automatically.

13. The method of claim 12, wherein said notification further includes a specification of the time at which the message would follow.

14. The method of claim 11, wherein said notification further includes an indication of the content of the message.

15. The method of claim 11, further comprising determining if a user wishes to receive the message associated with the notification.

16. A system for distributing a multimedia messaging service message, comprising:
a memory having program code stored therein; and
a processor operatively connected to said memory for carrying out instructions in accordance with said stored program code;
wherein said program code, when executed by said processor, causes said processor to perform the steps of:
dispatching to a device a notification of the availability of a multimedia messaging service message directed to the device, said notification including an indication of a remote location from which the message may be requested; and
dispatching said message,
wherein said message is not dispatched in response to a received request for said message.

17. The system of claim 16, wherein said message is dispatched prior to the dispatching of said notification.

18. The system of claim 16, wherein said message is dispatched along with said notification.

19. The system of claim 16, wherein said message is dispatched after the dispatching of said notification.

20. The system of claim 16, wherein said processor further performs the step of:
determining if a return communications channel is available to said device.

21. The system of claim 16, wherein said processor further performs the step of:
ascertaining if there is an advantage to avoiding use of the return channel.

22. The system of claim 21, wherein said ascertaining comprises determining the cost of using said return channel.

23. The system of claim 16, wherein said notification further includes an indication that the message will follow automatically.

24. The system of claim 23, wherein said notification further includes a specification of the time at which the message would follow.

25. The system of claim 16, wherein said notification further includes an indication of the content of the message.

26. A system for receiving a multimedia messaging service message, comprising:
a memory having program code stored therein; and
a processor operatively connected to said memory for carrying out instructions in accordance with said stored program code;
wherein said program code, when executed by said processor, causes said processor to perform the steps of:
receiving a notification of the availability of a multimedia messaging service message directed to the system, said notification including an indication of a remote location from which the message may be requested;
further receiving, along with said notification, said message;
placing said message in a cache of said system;
formulating a request to receive said message; and
employing said cache to satisfy said request.

27. The system of claim 26, wherein said notification further includes an indication that the message will follow automatically.

28. The system of claim 27, wherein said notification further includes a specification of the time at which the message would follow.

29. The system of claim 26 wherein said notification further includes an indication of the content of the message.

30. The system of claim 26, wherein said processor further performs the step of:
determining if a user wishes to receive the message associated with the notification.
